(19) United States
(12) Patent Application Publication
(10) Pub. No.: US 2007/0236919 A1
(43) Pub. Date: Oct. 11, 2007

(54) Illuminating device having changing patterns

(76) Inventor: Shen Ko Tseng, Taipei (TW)

Correspondence Address: CHARLES E. BAXLEY, ESQ., 90 JOHN STREET, THIRD FLOOR, NEW YORK, NY, 10038, US

(21) Appl. No.: 11/258,453

(22) Filed: Oct. 25, 2005

(51) Int. Cl. F21L 4/00

(52) U.S. Cl. 362/157

(57) ABSTRACT

An illuminating device includes a number of light members disposed on a panel and arranged in two or more different patterns each being formed by one or more of the light members, a circuit board is received in a housing and includes a control device electrically coupled to the light member and a switch coupled to the control device and the light members to control the light members of the patterns to light alternatively, and includes a battery coupled to energize the light members and the control device. The light members preferably include a relatively reduced or smaller volume for allowing the light members to be adhered onto the panel. The patterns may be heart-shaped, or star-shaped.

### BACKGROUND OF THE INVENTION

1. Field of the Invention

The present invention relates to an illuminating device, and more particularly to an illuminating device having two or more patterns that may be flashed or changed alternatively, for generating decorative flashing lights, or for identification and/or ensuring safety at night.

2. Description of the Prior Art

Typical light devices, illuminating devices or the like comprise a number of light members, such as light bulbs, light emitting diodes (LED), electro-luminescent members, etc. coupled to a circuit board with a switch which may control the light members to flash and/or to generate light alternatively or in series, for generating decorative flashing lights, and/or for identification and/or ensuring safety at night.

For example, U.S. Pat. No. 5,709,464 to the present inventor Tseng discloses one of the typical light devices, and also comprise a vibrating switch coupled to a number of light members, such as light emitting diodes, to control or to actuate the light members to flash and/or to generate light alternatively or in series, for generating decorative flashing lights, and/or for identification and/or ensuring safety at night.

The light members of the typical light devices may be arranged randomly or disposed in a predetermined single pattern. However, the light members are normally actuated or energized alternatively and in series.

U.S. Pat. No. 5,876,108 to Chien discloses another typical light device comprising a light arrangement in the form of a super-thin light element, such as an electro-luminescent or photo-luminescent strip or panel, and comprising a specially designed spring-biased motion sensitive switch.

However, similarly, the light arrangement may also be actuated or energized alternatively and in series similar to a circle or the like. The typical light devices fail to provide two or more patterns arranged or formed by a number of light members and arranged to allow the patterns to be actuated or energized alternatively and in series.

The present invention has arisen to mitigate and/or obviate the afore-described disadvantages of the conventional illuminating devices.

### SUMMARY OF THE INVENTION

The primary objective of the present invention is to provide an illuminating device including two or more patterns that may be flashed or changed alternatively, for generating decorative flashing lights, or for identification and/or ensuring safety at night.

In accordance with one aspect of the invention, there is provided an illuminating device comprising a panel, a number of light members disposed on the panel, and arranged in a first pattern which is formed by at least one of the light members, and at least one second pattern which is formed by at least two of the light members, a housing, a circuit board received in the housing and including a control device electrically coupled to the light member, and including a switch coupled to the control device and the light members to control the light members of the first pattern and the second pattern to light alternatively, and further including a battery coupled to energize the light members and the control device or other electrical elements.

The light members preferably include a relatively reduced or smaller volume having a length and a width and a height of 1.6 mm×0.8 mm×0.6 mm, for allowing the light members to be easily adhered or secured onto the panel.

The light members may be provided for generating different colors of lights. The second pattern is preferably arranged around the first pattern, and may include a heart shape, a star shape, or other shapes, which may be lighted or actuated or operated alternatively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an illuminating device in accordance with the present invention;

FIG. 2 is a partial plan view of the illuminating device;

FIGS. 3, 4, 5, 6 are partial plan views similar to FIG. 2, illustrating the operation of the illuminating device;

FIG. 7 is a partial plan view similar to FIG. 2, illustrating the other arrangement of the illuminating device; and

FIGS. 8, 9 are partial plan views illustrating the operation of the illuminating device as shown in FIG. 7.

### DETAILED DESCRIPTION OF THE PREFERRED EMBODIMENT

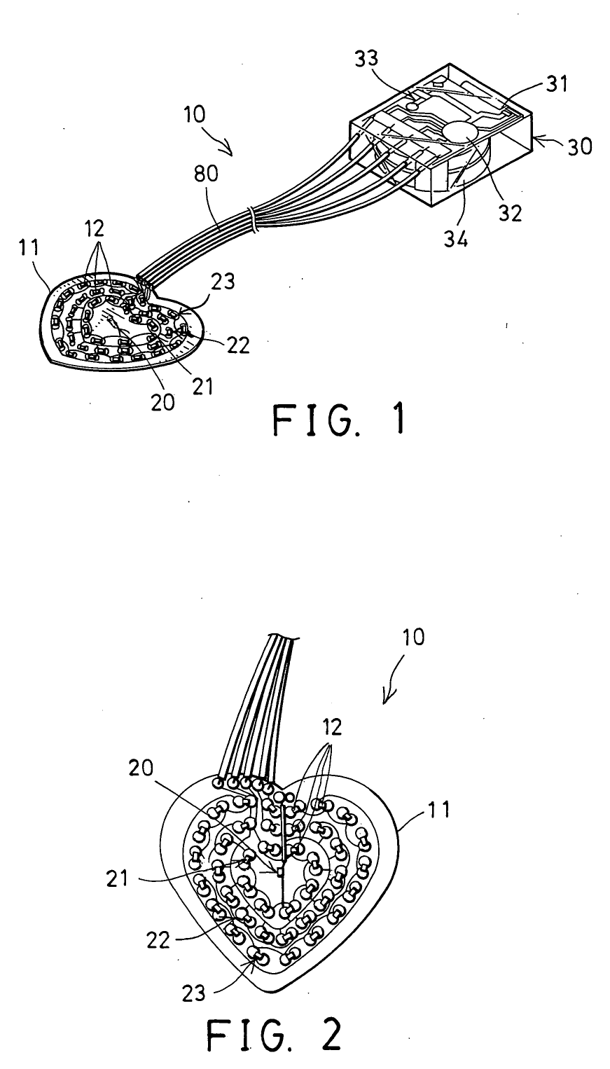

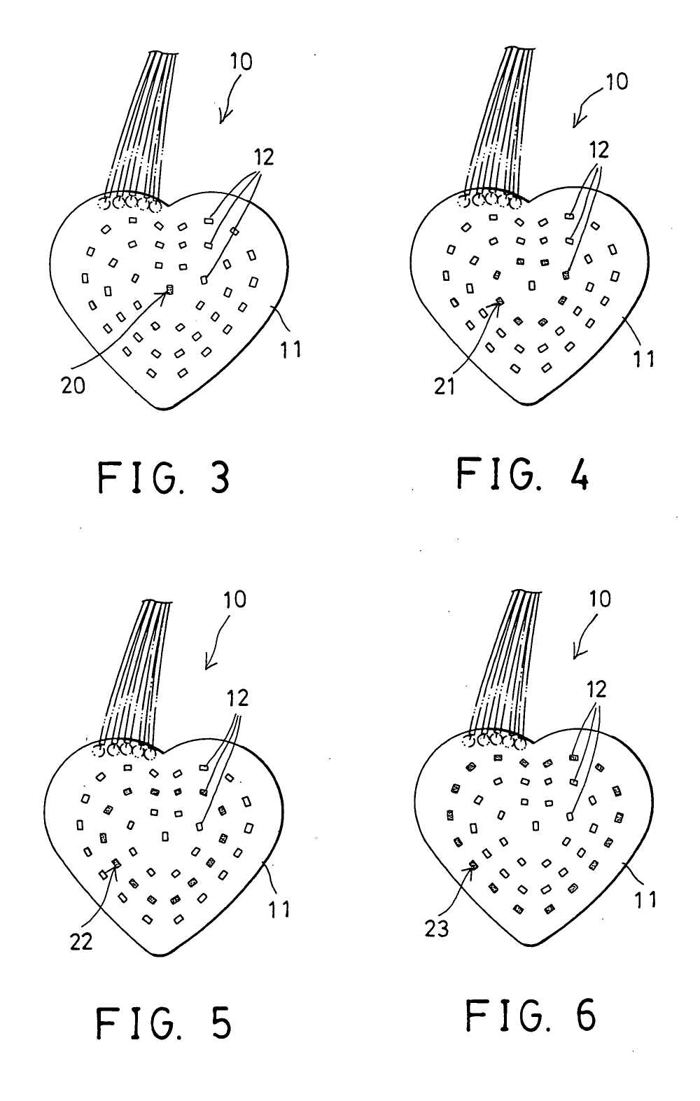

Referring to the drawings, and initially to FIGS. 1-3, an illuminating device 10 in accordance with the present invention comprises a plate or panel 11 preferably including a heart shape, and including a number of light members 12, such as light bulbs, light emitting diodes, electro-luminescent members, etc. disposed thereon, and arranged in two or more different patterns 20, 21, 22, 23, such as a first or a center of a heart 20 as shown in FIG. 3, a second or a relatively smaller heart pattern 21 as shown in FIG. 4, a third or a relatively increased or greater heart pattern 22 as shown in FIG. 5, and a fourth or a relatively increased or further greater heart pattern 23 as shown in FIG. 6.

It is preferable that the second or relatively smaller heart pattern 21 is disposed or arranged around or on the outer peripheral portion of the first or center of the heart 20, and the third or relatively increased or greater heart pattern 22 is disposed or arranged around or on the outer peripheral portion of the second pattern 21, and the fourth or relatively increased or further greater heart pattern. 23 is disposed or arranged around or on the outer peripheral portion of the third pattern 22, and arranged to allow the patterns 20, 21, 22, 23 to be actuated or energized or operated alternatively and in series. Each of the patterns 20-23 is formed or arranged by one or more light members 12.

For example, the patterns 20, 21, 22, 23 may be actuated or energized or operated alternatively from such as the center of the heart 20 to the relatively increased or further greater heart patterns 21, 22, 23, to represent or to indicate or to express that one person loves his lover. On the contrary, the patterns 23, 22, 21, 20 may be actuated or energized or operated or reduced alternatively from such as greatest heart patterns 23 to the other heart patterns 22, 21, and then to the center of the heart 20, to represent or to indicate or to express that one person do not love his lover any more.

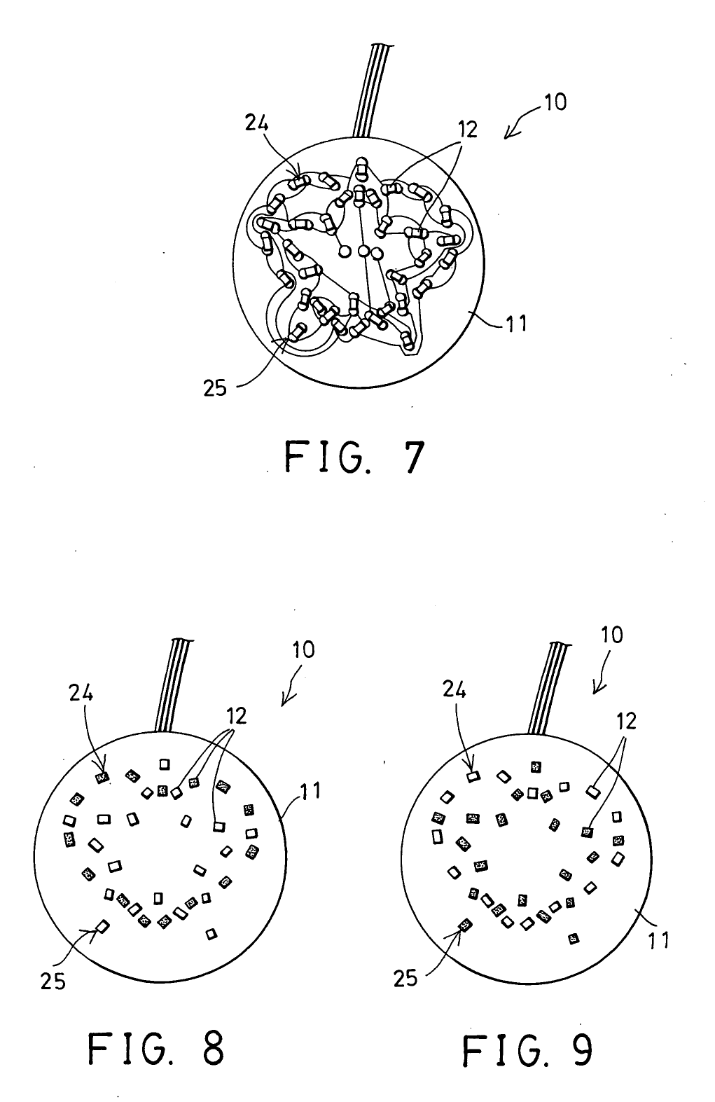

Alternatively, as shown in FIGS. 7-9, the plate or panel 11 may be formed or shaped into different structures or configurations, such as a circular shape, or the other shapes, and also includes a number of light members 12 disposed thereon and arranged in two or more different patterns 24, 25, such as a heart-shaped pattern 24, a star-shaped pattern 25, or the like. Each of the patterns 24, 25 is also formed or arranged by one or more light members 12. The patterns 24, 25 may also be actuated or energized or operated alternatively from such as the heart-shaped pattern 24 to the star-shaped pattern 25, or from such as the star-shaped pattern 25 to the heart-shaped pattern 24, to represent or to indicate or to express that one person loves his star-like lover.

As shown in FIG. 1, the illuminating device 10 further includes a housing 30 for receiving a circuit board 31 therein which includes a processor unit or control device 32 disposed in the housing 30 and electrically coupled to the light members 12 with one or more wires or cables 80, and includes a switch 33 coupled to or coupled between the processor unit or control device 32 and the light members 12, to control or to actuate the light members 12 of the patterns 20-23 or the patterns 24-25 to flash or to light different patterns 20-23, 24-25 alternatively or in series, for generating decorative flashing lights, and/or for identification and/or ensuring safety at night. One or more batteries 34 may be provided and electrically coupled to and to energize the light members 12 and/or the processor unit or control device 32. The switch 33 may be selected from the typical switches, the vibrating switches, the spring-biased motion sensitive switch, or the like.

The plate or panel 11 preferably includes a tiny or small area and includes a relatively thin or reduced thickness, for allowing the plate or panel 11 to be easily attached onto various objects or onto the clothes or the bodies of the users. The light members 12 are also made of or selected from relatively smaller light members 12, such as the mini-type LED which includes a length and a width and a height of about 1.6 mm×0.8 mm×0.6 mm, for allowing the mini light members 12 to be easily attached onto the panel 11 with such as adhesive materials, and for allowing the illuminating device 10 further to be easily attached onto various objects or onto the clothes or the bodies of the users. The light members 12 may be used to generate different colors of lights.

Accordingly, the illuminating device in accordance with the present invention includes two or more patterns that may be flashed or changed alternatively, for generating decorative flashing lights, or for identification and/or ensuring safety at night.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An illuminating device comprising:
a panel,
a plurality of light members disposed on said panel, and arranged in a first pattern which is formed by at least one of said light members, and at least one second pattern which is formed by at least two of said light members,
a housing,
a circuit board received in said housing and including a control device electrically coupled to said light member, and including a switch coupled to said control device and said light members to control said light members of said first pattern and said at least one second pattern to light alternatively, and including a battery coupled to energize said light members and said control device.

2. The illuminating device as claimed in claim 1, wherein said light members include a length and a width and a height of 1.6 mm×0.8 mm×0.6 mm.

3. The illuminating device as claimed in claim 1, wherein said light members are provided for generating different colors of lights.

4. The illuminating device as claimed in claim 1, wherein said at least one second pattern is arranged around said first pattern.

5. The illuminating device as claimed in claim 4, wherein said at least one second pattern is heart-shaped.
